(19) United States
(12) Patent Application Publication
(10) Pub. No.: US 2009/0328118 A1
(43) Pub. Date: Dec. 31, 2009

(54) METHODS, SYSTEMS, AND COMPUTER READABLE MEDIA FOR PROVIDING AN ENHANCED CALL ALERT SERVICE VIA A TELEVISION SERVICE NETWORK

(76) Inventors: Venkataramaiah Ravishankar, Cary, NC (US); Peter Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/434,610

(22) Filed: May 1, 2009

Related U.S. Application Data
(60) Provisional application No. 61/049,681, filed on May 1, 2008.
(60) Provisional application No. 61/049,885, filed on May 2, 2008.

(51) Int. Cl. H04N 7/173; H04M 11/00

(52) U.S. Cl. 725/106; 379/93.17

(57) ABSTRACT

Methods, systems, and computer readable media providing an enhanced call alert service via a television service network are described. In one embodiment, the system comprises a call alert service mediator (CASM) that includes a telephone network interface for receiving, from a telecommunications network, a query message for a call to a called party device associated with a subscriber for requesting instructions for completing or modifying the call. The CASM also includes a TV network interface for, in response to the query from the telecommunications network, for sending a message to a TV network, wherein the message results in notification of the call to the subscriber via an customer premises equipment (CPE) device and the requesting of instructions from the subscriber via the CPE device for completing or modifying the call.

### RELATED APPLICATIONS

This application claims the benefit of U.S. Provisional Patent Application Ser. No. 61/049,681, filed May 1, 2008 and U.S. Provisional Patent Application Ser. No. 61/049,885, filed May 2, 2008, the disclosures of which are incorporated herein by reference in their entireties.

### TECHNICAL FIELD

The subject matter described herein relates to television service networks and providing call alert messages to subscribers. More specifically, the subject matter relates to methods, systems, and computer readable media providing an enhanced call alert service via a television service network.

### BACKGROUND

Currently, services pertaining to incoming call alerts and displaying a calling party's information on a television screen while a subscriber is watching a program are provided by cable and satellite television operators. The current approach used by the television operators to provide these services is to connect a set top box (STB) to a phone line. The set top box is configured to detect the incoming call and display the calling party number and/or the calling party name on the television screen. However, this approach is limited in some aspects such that this call alert service is restricted to a single, fixed phone line. Notably, the current approach cannot be used to provide call alert information for calls intended for mobile phones, IP multimedia subsystem (IMS)/session initiation protocol (SIP) phones, Next Generation VoIP phones, and the like. This approach also requires a set top box to include a telephone transceiver terminal, which adds additional complexity and cost to the set top box.

Because the current approach for providing call alert service involves connecting an STB-based telephone terminal to a phone line, the call must be routed to the set top box in the customer premises before the subscriber can first be alerted. Moreover, the ringing of the call cannot be stopped or suspended while the calling party number is being displayed on the television screen.

Accordingly, a need exists for improved methods, systems, and computer readable media for providing an enhanced call alert service via a television service network.

### SUMMARY

Methods, systems, and computer readable media providing an enhanced call alert service via a television service network are described. In one embodiment, the system comprises a call alert service mediator (CASM) that includes a telephone network interface for receiving, from a telecommunications network, a query message for a call to a called party device associated with a subscriber for requesting instructions for completing the call. The CASM also includes an television service network interface for, in response to the query from the telecommunications network, for sending a message to a television service network, wherein the message results in notification of the call to the subscriber via an customer premises equipment (CPE) device and the requesting of instructions from the subscriber via the CPE device for completing the call.

In one embodiment, the method comprises receiving, from a telecommunications network, a query message for a call to a called party device associated with a subscriber for requesting instructions for completing the call. The method also includes, in response to the query from the telecommunications network, sending a message to an IPTV network, wherein the message results in notification of the call to the subscriber via a customer premises equipment (CPE) device and the requesting of instructions from the subscriber via the CPE device for completing the call.

The subject matter described herein for providing an enhanced call alert service may be implemented using a computer readable medium having stored thereon computer executable instructions that when executed by a processor of a computer perform steps of the aforementioned method (see above). Exemplary computer readable media suitable for implementing the subject matter described herein includes disk memory devices, programmable logic devices, and application specific integrated circuits. In one implementation, the computer readable medium may include a memory accessible by a processor. The memory may include instructions executable by the processor for implementing any of the methods for providing an enhanced call alert service described herein. In addition, a computer readable medium that implements the subject matter described herein may be distributed across multiple physical devices and/or computing platforms.

### BRIEF DESCRIPTION OF THE DRAWINGS

The subject matter described herein will now be explained with reference to the accompanying drawings of which:

FIG. 1 is a system diagram for providing an enhanced call alert service via an exemplary television service network using call alert service mediator in accordance with one embodiment of the subject matter described herein;

FIG. 2 is an exemplary flow diagram for providing a user control signal in response to a call alert signal in accordance with one embodiment of the subject matter described herein;

FIG. 3 is an exemplary call flow that depicts the utilization of a user response to accept an incoming call intended for a subscriber's public switched telephone network (PSTN) phone in accordance with one embodiment of the subject matter described herein;

FIG. 4 is an exemplary call flow that depicts the utilization of a user response to redirect an incoming call that is intended for a subscriber's switched telephone network (PSTN) phone to a voice mail server in accordance with one embodiment of the subject matter described herein;

FIG. 5 is an exemplary call flow that depicts the utilization of a user response to redirect an incoming call intended for a subscriber's non-roaming mobile phone to a voice mail server in accordance with one embodiment of the subject matter described herein; and

FIG. 6 is an exemplary call flow that depicts the utilization of a user response to redirect an incoming call intended for an available IP multimedia subsystem (IMS)/session initiation protocol (SIP) phone to a voice mail server in accordance with one embodiment of the subject matter described herein.

### DETAILED DESCRIPTION

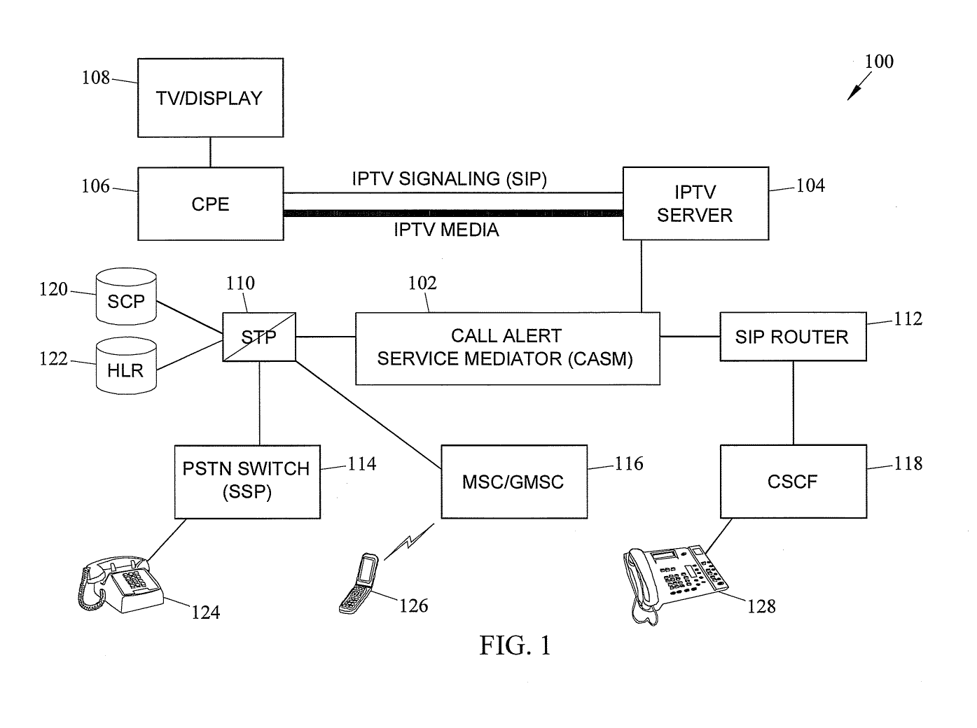

FIG. 1 depicts a diagram of an exemplary system 100 that is configured for providing an enhanced call alert service to subscribers of a television service network. Although FIG. 1 and the following disclosure describes system 100 as utilizing an IPTV service, any other television service network, such as Internet television service network, a broadband television service network, a cable television service network, a satellite TV service network, and the like may be used without departing from the scope of the present subject matter.

In one embodiment, system 100 enables an IPTV subscriber to receive a call alert notification, which is displayed on an IPTV display device, where the call alert notification indicates that a calling party is attempting to contact one of the IPTV subscriber's communication devices (e.g., mobile phone, office phone, home phone, etc.). A call alert of this type may be generated for a POTS/black phone, an IP phone (e.g., a SIP/IMS phone, a VoIP phone, etc.) and/or a mobile phone. It will be appreciated that call alerts of the type disclosed by the present subject matter may be provided for phones, telephone numbers (e.g., PSTN number, mobile number, MSISDN, short code identifiers, etc.), SIP contact addresses (e.g., uniform resource identifiers, SIP identifiers, etc.) associated with the subscriber and/or members of the subscriber's family.

In one embodiment, system 100 includes at least a call alert service mediator (CASM) 102, a TV server 104 (e.g., an IPTV server or a headend server), and customer premises equipment (CPE) 106. In one embodiment, CASM 102 may be located in a telecommunications network (e.g., public switched telephone network, mobile network, session initiation protocol (SIP) network, IP multimedia subsystem (IMS) network, etc.), TV server 104 may reside in an IP network, and CPE 106 may reside in a subscriber's home, or customer premises.

In one embodiment, a user associated with CPE device 106 is subscribed to an IPTV service, an enhanced call alert feature, and some combination of mobile phone service, IP phone service, PSTN phone service, or the like. For example, the subscriber's call information (e.g., phone number, customer premises location information, subscriber services, etc.) is provided to CASM 102 and may be provisioned in an associated IPTV subscriber database (not shown), accessible to the CASM 102.

In one embodiment, CPE device 106 and TV server 104 are configured to exchange signaling information in order to allow TV server 104 to provide CPE device 106 with television programming, which is transmitted over an IPTV media connection, to CPE device 106. Notably, the signaling conducted between CPE device 106 and TV server 104 may include any type of signaling, such as IP signaling, non-IP signaling, SIP signaling, non-SIP signaling, and the like. In one embodiment, the television programming is provided to a display 108 from CPE device 106 for the subscriber's viewing. As the subscriber is watching television, a network element such as PSTN end office switch 114 may monitor any received signaling information to detect any incoming call or call setup messages intended for any of the subscriber's subscribed phones. For example, receipt of a call setup message, such as an ISUP IAM message, associated with a call attempt to a phone number that has been selected for enhanced call alert service triggers switch 114 to suspend or pause setup of the call and to generate an Initial Detection Point (IDP) query message associated with the incoming call. In one embodiment, the IDP query message requests instructions related to how the call is to be treated (e.g., allow the call, re-direct to voice mail, re-direct to another number, block/reject the call, etc.). The use of IDP queries and associated responses to determine call disposition/how to route a call is well known in the telecommunications industry. It will be appreciated that different networks may employ different signaling protocols and messages (e.g., SIP, SOAP, XML, etc.) to provide similar call disposition resolution processes.

In one embodiment, the present subject matter may be used by a subscriber to only monitor received call alerts (e.g., not providing user control responses). For example, an IPTV subscriber may have either TV server 104 or CASM 102 be provisioned to provide call alerts for some or all calls to the phones of the subscriber's family members (e.g., children). According to various embodiments of the present subject matter, the IPTV subscriber may receive notification regarding an incoming call for his/her child, where the notification includes caller ID information for the caller. According to one embodiment, the notification may simply be informational, in which case the IPTV subscriber may not exert control over or influence the disposition of the incoming call (i.e., the IPTV subscriber cannot block or reject the call). In another embodiment, the IPTV subscriber is given call control options (via the IPTV display interface) that permit the IPTV subscriber to block or reject the call from an unwanted caller, or to allow the call to proceed to the child's phone.

Returning to FIG. 1, CASM 102 may be configured to receive query messages, such as initial detection point (IDP) or INVITE messages from a telecommunications network element such as a PSTN switching service point (SSP) associated with a call setup request for the establishment of a call between a calling party and one of the called party's subscriber phone devices. CASM 102 may receive an IDP or comparable message from any of a number of different network elements including, but not limited to PSTN SSP switch 114 via signal transfer point (STP) 110 or from mobile switching center (MSC) 126 via STP 110. CASM 102 may also receive SIP based signaling message from a call session control function (CSCF) 118 directly or via SIP router 112. In one embodiment, the query messages include query messages associated with suspended or paused call setup processing at a telecommunications node (e.g., switch 114, MSC 116, or CSCF 118). The query message may request instructions for completing a call that has been suspended during the call setup process. In one embodiment, a call may be suspended by provisioning the telecommunications nodes (e.g., SSP, MSC, CSCF, etc.) with a trigger for suspending any call setup directed to a phone number or contact address that has been provisioned to trigger enhanced call alert service.

Depending on the native network type (e.g., PSTN, mobile, IP, IMS, etc.) of the called device, CASM 102 may handle the call control query message differently. For example, if the called party number is associated with a switched telephone network (PSTN) phone (e.g., phone device 124), a terminating trigger may be established at a PSTN switch 114 for the PSTN number associated with the called subscriber. Existing terminating triggers for services, such as Calling Name Delivery, Inbound Call Screening, may be used. When an incoming call setup message is received, PSTN switch 114 (or other telecommunications node) may suspend the call and send a call control query message (e.g., a terminating trigger message such as an IDP message) to CASM 102.

Alternatively, if the called party number is associated with an IP phone, an initial Filter Criteria (iFC) may be established at CSCF 118. When an incoming call setup message intended for a subscriber's IP phone (e.g., phone device 128) is received, CSCF 118 may send a SIP INVITE message (i.e., a query message) to CASM 102 requesting call control instructions. In one embodiment, a SIP proxy server (not shown) may be configured to intercept an inbound SIP INVITE message and redirect it to CASM 102.

If the subscriber is a mobile subscriber, gateway MSC (GMSC) 116 may send a Send Routing Information (SRI) message to home location register (HLR) 122 in a global system for mobile communications (GSM) network to determine the current location and/or registration status of the subscriber. In an alternate embodiment, a Location Request message may be sent to an HLR in a code division multiple access (CDMA) network. STP 110 may forward a copy of the SRI message and the response to CASM 102 as a query message. Similarly, a terminating trigger may be set at GMSC 116 for the subscriber. When an incoming call setup message is received, GMSC 116 may suspend the call and send a call control query (e.g., a terminating trigger message, such as an IDP message) to CASM 102. Alternatively, an existing terminating trigger for services, such as Calling Name Delivery, Inbound Call Screening, can also be used. When an incoming call is received, GMSC 116 suspends the call and sends the call control query message (e.g., an IDP message in GSM networks) to a service control point (SCP). STP 110 may intercept this query message and redirect it to CASM 102.

Once a query message (e.g., an IDP message, indicating that an incoming call is in a suspended state) is received at CASM 102, CASM 102 may generate a query to one or more external subscriber databases (e.g., SCP 120) to obtain details pertaining to calling party identification. For example, one database may include a National Calling Name (CNAM) Database, in which case CASM 102 sends an SS7-based GR-1188 specified query (e.g., calling name request, calling party number) and the CNAM database will respond with a GR-1188 response message (e.g., calling party names). Other databases may include, but are not limited to, a registered sex offender database, a telemarketer database that identifies telemarketers, a blacklist database that identifies callers from whom calls are not desired by the subscriber, etc. Additional databases may be queried in a similar manner to obtain additional information on the calling subscriber without departing from the scope of the present subject matter.

In one embodiment, as mentioned above, CASM 102 is adapted to query one or more registered sex offender databases to determine whether the calling party associated with an incoming call is listed as a registered sex offender. If the caller is determined to be a registered sex offender, then this information is displayed to the IPTV subscriber via the call alert message. In another embodiment, such a call attempt by a calling party that is determined to be a registered sex offender may be automatically blocked or rejected if a call disposition control action (i.e., a user control action) is not received from the IPTV subscriber within a predetermined time period (e.g., the IPTV subscriber may have stepped away from the IPTV display at the time the call alert notification is received and displayed).

In addition to obtaining information about the calling party, CASM 102 may obtain information pertaining to the called party. In one embodiment, CASM 102 may query a location server (e.g., HLR 122) to identify the present location of a roaming called party subscriber or a mobile device. For example, if the call is made to a subscriber's GSM mobile device, then CASM 102 may send an ATI query or SRI query to HLR 122. For calls made to IP phones, CASM 102 may query a SIP location registrar or presence server. In an alternate embodiment, location information may be obtained directly from the incoming signaling message. For example, in GSM network, location information is embedded as a parameter in the received IDP message and may be extracted by CASM 102.

If a particular phone device (e.g., a PSTN phone) does not allow for mobility and/or roaming, then CASM 102 may be configured to assume that a called subscriber is at home. However, if a subscriber's mobile phone is called, CASM 102 may determine if the subscriber is at home after fetching the location of the subscriber from a location server. In one embodiment, CASM 102 can query a HomeZone database (not shown) to find the coordinates of the location of the subscriber's home (i.e., the customer premises). In an alternate embodiment, the customer premises data may be provisioned per the subscriber at CASM 102. In both of the aforementioned embodiments, CASM 102 may then compare the subscriber's location from the HLR with the customer premises location information to ascertain if the subscriber device is proximate to the subscriber's home or CPE device.

If the subscriber device is currently located near the customer premises, CASM 102 may create a call alert signal, which includes calling party information such as phone number, name and/or SIP addresses, and send the call alert signal to TV server 104. For example, a SIP INFO message may be used to communicate the call alert signal to TV server 104.

Once the initial call processing (e.g., determining presence and location information of the called party, obtaining the calling name of the calling party, etc.) is performed, CASM 102 generates a call alert signal. In one embodiment, the call alert signal is directed to an IPTV server network that provides IPTV service to the called party. For example, referring to FIG. 1 CASM 102 may send the call alert signal to TV server 104. After receiving the call alert signal, TV server 104 may generate a call alert message (that may contain some or all of the same or similar calling and called party information as the call alert signal transmitted by CASM 102), which is compatible for traversing an IPTV network over an IPTV signaling connection, and capable of being processed by CPE device 106. In one embodiment, the IPTV signaling connection between TV server 104 and CPE device 106 is configured to communicate via SIP signaling messages.

After receiving the call alert message, CPE device 106 may be used by TV server 104 to display the call alert message on the subscriber's TV screen. For example, TV server 104 may display the calling party identification data on TV/display 108 via CPE device 106. In one embodiment, the calling party identification data may include data such as the calling party number and calling party name, as well as other information associated with the calling party such as SIP address of the calling party. Using display 108, TV server 104 may also prompt the subscriber to provide instructions as to how to handle or complete the suspended, incoming call. Options may include ignoring the call, redirecting the call to a different number, forwarding the call to the voice mail, or receiving the call. In one embodiment, there may be a query display 108 that presents the subscriber's options. In an alternate embodiment, display 108 does not provide a query to the subscriber, but CPE device 106 is nonetheless configured to receive the user's instructions (e.g., in cases where the user has memorized the option choices).

In one embodiment, a subscriber may respond to the call alert message by providing a subscriber response to CPE device 106, such as via a remote control. For example, the subscriber's response may be captured by CPE device 106 and sent to TV server 104. TV server 104 may be configured to inform CASM 102 via a “user response” message of the subscriber response (e.g., via a signaling message). In one embodiment, TV server 104 may use a SIP INFO message (which includes the subscriber response information) to CASM 102. Depending on the subscriber response, CASM 102 is configured to perform a number of functions. For example, if the user response message indicates the normal continuation of the call, CASM 102 may instruct the original network element that provided the call request (e.g., switch 114, MSC 116, or CSCF 118) to continue normally with the call (e.g., resume the call). Standard IN/AIN or SIP protocols may be used for this purpose. For example, if the incoming call was intended for subscriber's PSTN phone, CASM 102 may respond to the IDP message by sending PSTN switch 114 a CUE message.

If the user response message indicates the termination of the call, CASM 102 may instruct the original network element that provided the call request (e.g., switch 114, MSC 116, or CSCF 118) to terminate the call and provide a “network busy” message as the reason. Standard IN or SIP protocols may be used for this purpose. For example, if the incoming call was intended for a subscriber's PSTN phone, CASM 102 may respond to the IDP message by sending PSTN switch 114 a REL message.

If the user response message indicates redirection of the call to a different number or a voice mail server, CASM 102 may instruct the original network element (e.g., switch 114, MSC 116, or CSCF 118) that provided the call request to forward the call to a new number (e.g., a second phone device previously designated by the subscriber) or voice mail. Standard IN or SIP protocols may be used for this purpose. For example, if the incoming call was intended for a PSTN phone, CASM 102 would respond to the IDP message by sending PSTN switch 114 a CON response message (i.e., containing the number to be forwarded).

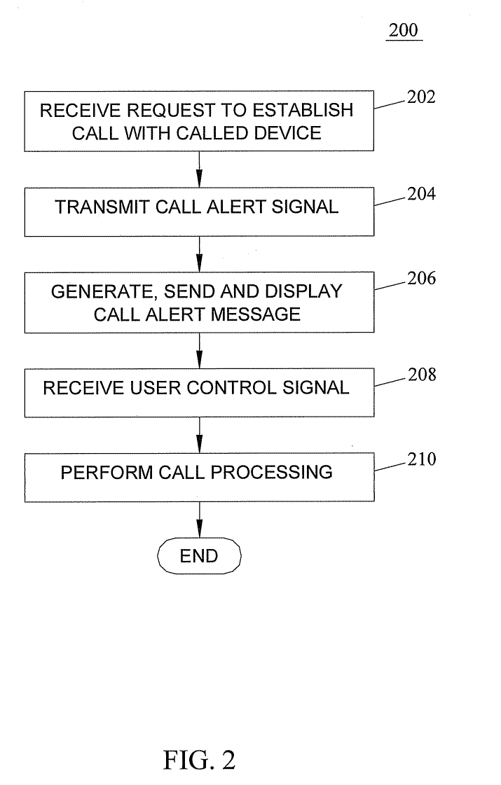

FIG. 2 is a flow chart that provides exemplary steps for providing a user control signal in response to a call alert signal in accordance with one embodiment of the subject matter described herein. In one embodiment, the following method may be embodied as a computer program product in a computer readable medium.

In block 202, a request to establish a call with a called device is received. In one embodiment, a subscriber may subscribe to a packaged service that includes regular phone service, mobile phone service, IP phone service with IPTV capability, IPTV at home, and enhanced call alert service with calling name display. At some time, a calling party calls the subscriber on any one of the subscriber's aforementioned phone devices while the subscriber is viewing television. For example, the calling party may call the subscriber's mobile phone (e.g., mobile phone 126). Eventually, MSC 116 receives a call setup message. If MSC 116 is provisioned with the subscriber's mobile phone number as a trigger, MSC 116 may be configured to suspend the call and send an IDP message to CASM 102.

In block 204, a call alert signal is transmitted. In one embodiment, after determining that the subscriber has subscribed to the enhanced call alert service and determines that the subscriber's mobile phone is located near the customer premises (e.g., using a location database), CASM 102 may generate a call alert signal that includes, for example, the calling party name and number. The call alert signal may be received by a TV server 104, which is responsible for providing IPTV service to the subscriber. As mentioned above, the present subject matter is not limited to utilizing IPTV service, but rather may be implemented with any television service network in which an interface exists between the TV server 104 (or a headend server of a TV network) and CASM 102 and control message, such as the call alert signal and user control actions (as mentioned below), can be communicated.

In block 206, a call alert message is generated, sent and displayed. In one embodiment, TV server 104 generates a call alert message using the call alert signal received from CASM 102. For example, TV server 104 obtains the calling party information and the calling party information (e.g., the subscriber's mobile phone number being called) from the call alert signal (which is a telecommunications network signal) and incorporates the data into a call alert message (which is an IPTV network message). TV server 104 may then send the call alert message to a CPE device belonging to the subscriber/called party. After receiving the call alert message, the CPE device (e.g., CPE device 106) may display the information contained in the call alert message on TV/display 108. For example, the calling party's name, number, and the subscriber device being called may be displayed on TV/display 108.

In block 208, a user control signal is received. In one embodiment, the subscriber may respond to the call alert message displayed on TV/display 108. For example, the subscriber may use a television or CPE remote control (e.g., a hand-held IPTV remote control device) to input an instruction that indicates how the call should be handled or completed. In one embodiment, the permitted actions include allowing the call to be received normally, ignoring/rejecting/blocking the call, redirecting the call to a different phone device, or forwarding the call to voice mail. It will be appreciated that while the call is in a suspended state, the called phone does not ring. Ringing of the called phone does not occur unless and until the IPTV subscriber that is controlling the call makes a decision that permits call setup to resume towards the called party phone. If, for example, the IPTV subscriber chooses to block the call or redirect the call to voicemail, the subscriber's called phone device or terminal does not ring.

In block 210, the appropriate call processing is performed. In one embodiment, TV server 104 receives a subscriber response message (which includes the instructions indicated by the user control signal) from CPE device 106. ITPV server 104 may then forward the instructions via a user response message (e.g., a SIP INFO message) to CASM 102. CASM 102 may then, alone or with MSC 116 (i.e., the original network node that contacted CASM 102), process the suspended call. If the call is to be continued normally, then call setup to the called party telephone terminal is resumed. In one embodiment, while the IPTV subscriber is determining how to handle the incoming call, the calling party may be presented with an appropriate announcement message which indicates that the call is being processed. If the user response message indicated that the call should be ignored/blocked/rejected, then the call may be released with a busy tone. If the user response message indicated that the call be redirected to another phone or forwarded to voice mail, then the call may be resumed and re-routed accordingly.

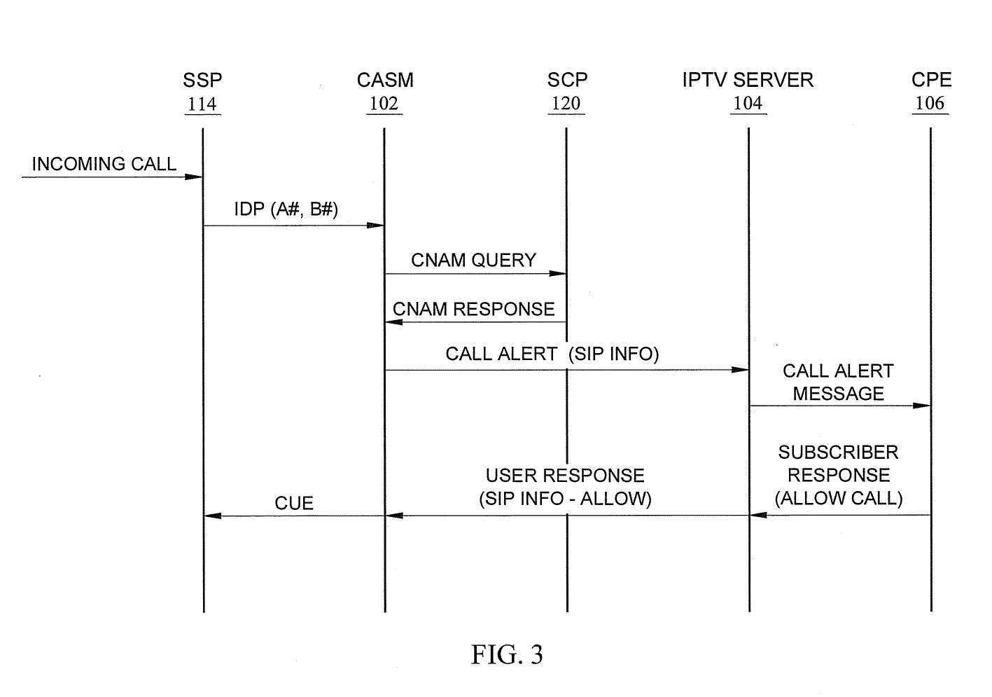

To better illustrate the cooperation among the network elements in system 100 and how the aforementioned user responses address the call alert signals to complete a call, exemplary call flows are described below and presented in FIGS. 3, 4, 5, and 6. FIG. 3 illustrates an exemplary call flow diagram of utilizing a user response to accept an incoming call intended for a subscriber's PSTN phone. Namely, FIG. 3 depicts service switching point (SSP) 114 (i.e., PSTN switch 114) receiving an incoming call request message (e.g., a call setup message) from a calling party. In one embodiment, SSP 114 suspends the call (e.g., due to an established trigger) and generates an IDP message containing calling party (A#) and called party (B#) information. The IDP message is then sent to CASM 102. After receiving the IDP message, CASM 102 may determine if an enhanced call alert subscription is applicable to the called party by comparing the called party number with subscription data stored either internally or externally (e.g., databases). For mobile subscribers, the subscription data may be stored in an HLR. Subscription data can also be carried in the IDP message if the originating switch contains the subscription data. If CASM 102 determines that the called party is a subscriber, CASM 102 may then decide that a CNAM database needs to be accessed. CASM 102 may then send a CNAM query containing the calling party number to SCP 120 (e.g., a CNAM database), which returns a CNAM response message that includes the name of the calling party. CASM 102 may then generate a call alert signal to be sent to TV server 104. In one embodiment, the call alert signal includes a SIP INFO message that contains the calling party number and the calling party name. After receiving the call alert signal, TV server 104 transmits a call alert message to CPE device 106. Once received, the call alert message (e.g., calling party name and number) is displayed by CPE device 106 on TV/display 108.

In one embodiment, a subscriber may respond to the call alert message by providing a subscriber response with instructions for receiving the call (e.g., selecting a call processing option via an IPTV or CPE remote control). TV server 104 may receive the subscriber response message and generate a user response message, such as a SIP INFO message, 200 OK message, or some other message indicating that the call should be allowed. The SIP INFO message is then sent to CASM 102. In response, CASM 102 generates a CUE message indicating that the call should continue normally, and forwards the message to SSP 114. SSP 114 may then resume call setup processing associated with the call and the called party's phone may begin to ring.

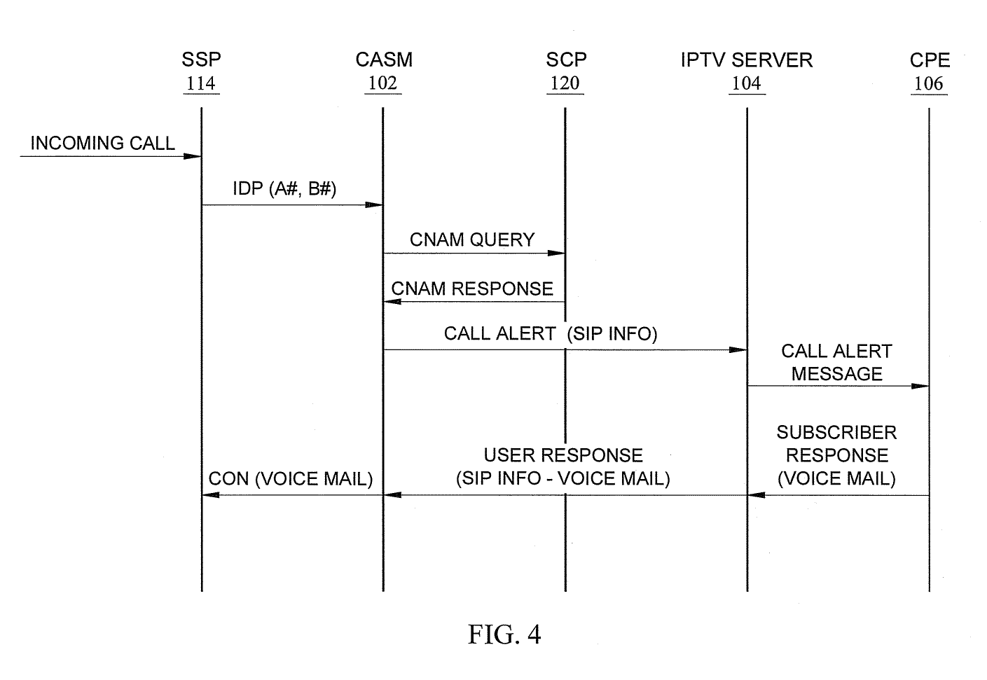

FIG. 4 illustrates an exemplary call flow diagram of utilizing a user response to redirect an incoming call (intended for a subscriber's PSTN phone) to a voice mail server. Namely, FIG. 4 depicts SSP 114 (i.e., PSTN switch 114) receiving an incoming call request message (e.g., a call setup message) from a calling party. In one embodiment, SSP 114 suspends the call (e.g., due to an established trigger) and generates an IDP message containing calling party (A#) and called party (B#) information. The IDP message is then sent to CASM 102. After receiving the IDP message, CASM 102 may determine if an enhanced call alert subscription is applicable to the called party by comparing the called party number with subscription data stored either internally or externally (e.g., databases). If CASM 102 determines that the called party is a subscriber, CASM 102 may then decide that a CNAM database needs to be accessed. CASM 102 may then send a CNAM query containing the calling party number to SCP 120 (e.g., a CNAM database), which returns a CNAM response message that includes the name of the calling party. CASM 102 may then generate a call alert signal to be sent to TV server 104. In one embodiment, the call alert signal includes a SIP INFO message that contains the calling party number and the calling party name. After receiving the call alert signal, TV server 104 transmits a call alert message to CPE device 106. Once received, the call alert message (e.g., calling party name and number) is displayed by CPE device 106 on TV/display 108.

In one embodiment, a subscriber may respond to the call alert message by providing a subscriber response with instructions for redirecting the call (e.g., selecting a call processing option via an IPTV or CPE remote control). TV server 104 may receive the subscriber response message and generate a user response message, such as a SIP INFO message, a 200 OK message, or some other message indicating that the call should be redirected to voice mail. The SIP INFO message is then sent to CASM 102. In response, CASM 102 generates a CON message indicating that the call should be redirected to a particular voice mail server at a particular number. CASM then forwards the CON message to SSP 114. SSP 114 may then resume setup processing associated with the call, and redirect/connect the call to an appropriate voice mail server. Notably, the called party's phone does not ring at any time.

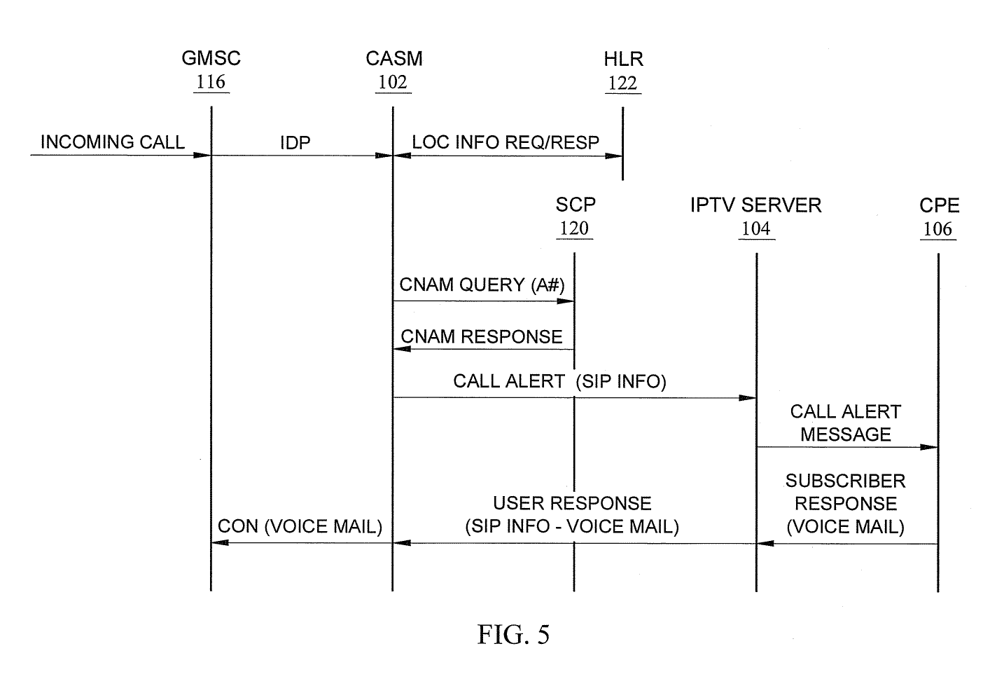

FIG. 5 illustrates a call flow diagram of utilizing a user response to redirect an incoming call intended for a non-roaming mobile phone to a voice mail server. Namely, FIG. 5 depicts GMSC 116 receiving an incoming call request message (e.g., a call setup message) from a calling party. In one embodiment, GMSC 116 suspends the call (e.g., due to an established trigger) and generates an IDP message containing calling party (A#) and called party (B#) information. The IDP message is then sent to CASM 102. After receiving the IDP message, CASM 102 determines if the enhanced call alert subscription is applicable to the called party by comparing the called party number with subscription data stored either internally or externally (e.g., databases). After determining that the called party is a subscriber to the enhanced call alert services, CASM 102 sends a Location Information Request message to a location server (e.g., HLR 122). CASM 102 then obtains a location information response message from the location server, which provides information as to the location of the called mobile device. With this location information, CASM 102 may determine if the called mobile device is proximately located to the customer premises (e.g., comparing the location information with customer premises data stored in a subscriber information database). If CASM 102 determines that the mobile device is proximately located to the customer premises, CASM 102 may proceed by accessing a CNAM database. CASM 102 may then send a CNAM query containing the calling party number to SCP 120 (e.g., a CNAM database), which returns a CNAM response message that includes the name of the calling party. CASM 102 then generates a call alert signal that is sent to TV server 104. In one embodiment, the call alert signal includes a SIP INFO message that contains the calling party number and the calling party name. After receiving the call alert signal, TV server 104 transmits a call alert message to CPE device 106. Once received, the call alert message (e.g., calling party name and number) is displayed by CPE device 106 TV/Display 108.

In one embodiment, a subscriber may respond to the call alert message by providing a subscriber response with instructions for redirecting the call (e.g., selecting a call processing option via an IPTV or CPE remote control). TV server 104 may receive the subscriber response message and generate a user response message (e.g., a SIP INFO message) indicating that the call should be redirected to voice mail. The SIP INFO message is then sent to CASM 102. In response, CASM 102 generates a CON message indicating that the call should be redirected to a particular voice mail server at a particular number. CASM 102 then forwards the CON message to GMSC 116. GMSC 116 may then resume call setup processing associated with the call and connect the call to the indicated voice mail server. Notably, the called party phone never rings.

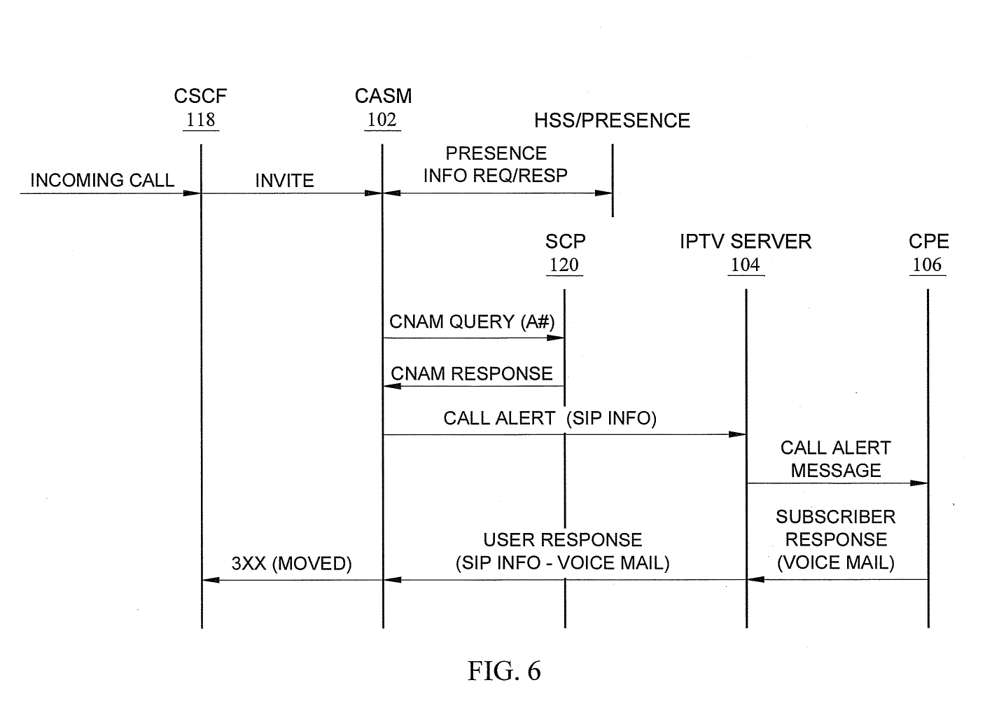

FIG. 6 illustrates an exemplary call flow diagram of utilizing a user response to redirect an incoming call intended for an available IP phone to a voice mail server. Namely, FIG. 6 depicts CSCF 118 receiving an incoming call request message (e.g., a call setup message) from a calling party. In one embodiment, CSCF 118 suspends the call (e.g., due to an established IFC trigger) and generates INVITE message containing calling party and called party information. The INVITE message is then sent to CASM 102. After receiving the INVITE message, CASM 102 determines if the call alert subscription is applicable to the called party by comparing the called party number with subscription data stored either internally or externally (e.g., databases). After determining that the called party is a subscriber to the enhanced call alert services, CASM 102 may send a presence information request message to a presence server (e.g., SCP 122). In one embodiment, CASM 102 may then obtain a presence information response message from the presence server, which provides presence information (e.g., subscriber availability or “reachability” information) related to the subscriber's IP phone device. Using the presence information, CASM 102 may determine if the called subscriber called mobile device is available to answer a call using the IP phone. If CASM 102 determines that the IP phone is available, CASM 102 may access a CNAM database. CASM 102 may then send a CNAM query containing the calling party number to SCP 120 (e.g., a CNAM database), which returns a CNAM response message that includes the name of the calling party. CASM 102 then generates a call alert signal that is sent to TV server 104. In one embodiment, the call alert signal includes a SIP INFO message that contains the calling party number and the calling party name. After receiving the call alert signal, TV server 104 may transmit a call alert message to CPE device 106. Once received, CPE device 106 displays the call alert message (e.g., calling party name and number) on TV/display 108.

In one embodiment, a subscriber may respond to the displayed call alert message by providing a subscriber response with instructions for redirecting the call (e.g., selecting a call processing option via a TV or CPE remote control). TV server 104 may receive the subscriber response message and generate a user response message (e.g., a SIP INFO, 200 OK, or other SIP message) indicating that the call should be redirected to voice mail. The SIP INFO message is then sent to CASM 102. In response, CASM 102 generates a CON message indicating that the call should be redirected to a particular voice mail server at a particular number. CASM 102 then forwards a 3XX (Moved) message to CSCF 118. CSCF 118 may then resume the call and connect the call to the indicated voice mail server. Notably, the called party's IP phone never rings.

In one embodiment, the present subject matter may allow an incoming call to a subscriber device to proceed normally if no user control signal is received. For example, a predetermined time period (i.e., a “time-out” period) may be implemented in CASM 102 (or alternatively the TV server 104, or CPE device 106) such that if the call alert message is delivered to CPE device 106 and a user control signal is not received from the subscriber after an established period of time, then the CASM 102 (or alternatively the TV server 104, or CPE device 106) automatically resumes the suspended call.

In one embodiment, the abovementioned enhanced call alert services may be implemented as standard services or subscription based services. If subscription based service model is used, then the above actions are performed only if the called party has subscribed to the enhanced call alert service. There are several ways that CASM 102 may determine the service subscription states. For example, if a subscription based model is implemented, the subscription information for each subscriber may be provisioned within a subscriber information database residing in CASM 102. In such case, CASM 102 can lookup the internal subscriber database. Alternatively, the subscription information can instead be stored in an external subscriber database, such as an HLR. In such a case, CASM 102 can query the external database to obtain the subscription information. In yet another embodiment, the subscription information may instead be contained in the incoming signaling message that was received by CASM 102. For example, in the case of a GSM network, the terminating IDP trigger message may contain a “service key” that is used to identify the service profile of the subscriber.

In the examples described above, the call is suspended to obtain user input via the television network. In an alternate embodiment call suspension is not required. For example, when a call is made to a subscriber who has the service provisioned herein, the call will proceed and the phone will ring. The CASM will be queried, and the user will respond as described above. The call will be modified according to the user action. The call may be released if the user refuses the call, or the call may be redirected to voice mail if the user selects this option.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for providing an enhanced call alert service via a television service network, the system comprising:
a call alert service mediator (CASM) including:
a telephone network interface for receiving, from a telecommunications network, a query message for a call to a called party device associated with a subscriber for requesting instructions for completing or modifying the call; and
a television (TV) service network interface for, in response to the query message from the telecommunications network, for sending a message to a TV network, wherein the message results in notification of the call to the subscriber via a customer premises equipment (CPE) device and the requesting of instructions from the subscriber via the CPE device for completing the or modifying the call.

2. The system of claim 1 comprising:
a TV server, locatable in the TV network, for receiving the message sent to the TV network, and for transmitting a call alert message that contains calling party information and serves as the request for instructions for completing or modifying the call; and
wherein the CPE device is configured for receiving the call alert message, and for displaying the call alert message via a display interface, and wherein the called party device is not associated with the CPE device.

3. The system of claim 1 wherein the called party device is not directly connected to the CPE device.

4. The system of claim 1 wherein the query message includes an initial detection point (IDP) message and the IDP message includes a call alert signal.

5. The system of claim 2 wherein the CPE device is configured to receive a user control signal from the subscriber responding to a displayed call alert message, wherein the user control signal provides instructions for completing or modifying the call.

6. The system of claim 5 wherein the user control signal is provided to the CPE device via a remote controller.

7. The system of claim 5 wherein the user control signal includes a signal for at least one of: resuming the call, resuming the call after a delay, resuming and redirecting the call a subscriber-specified called device, resuming and redirecting the call to a voice mail server, and rejecting the call.

8. The system of claim 7 wherein the CASM provides an announcement message to a calling party associated with the call after a delay.

9. The system of claim 5 wherein the TV server is configured to receive the user control signal from the CPE device and to forward a user response message including instructions provided by the user control signal to the CASM.

10. The system of claim 2 wherein the called party device is one of a plurality of called party devices not associated with the CPE device.

11. The system of claim 10 wherein the called party device includes at least one of a mobile phone device and a session initiation protocol (SIP) phone device.

12. The system of claim 1 wherein the CASM is located in the telecommunications network.

13. The system of claim 2 wherein the CPE device is located in a customer premises.

14. The system of claim 2 wherein the display interface includes a television screen.

15. The system of claim 2 wherein the CASM is configured to determine, based on called party location information, whether the called party device is proximately located to the CPE device, and, in response to determining that the called party device is not proximately located to the CPE device, to refrain from forwarding the message to the CPE device and, in response to determining that the called party device is proximately located to the CPE device, to forward the message to the CPE device.

16. The system of claim 2 wherein the CASM is configured to determine based on called party presence information and called party location information, whether the called party device is available in a location proximate to the CPE device, and, in response to determining that the called party device is not available in the location proximate to the CPE device, to refrain from forwarding the message to the CPE device and, in response to determining that the called party device is available in the location proximate to the CPE device, forwarding the message to the CPE device.

17. The system of claim 10 wherein at least one of the plurality of called party devices includes a called party device belonging to a family member of the subscriber.

18. The system of claim 17 wherein the CASM obtains calling party data from at least one of a calling name (CNAM) database, a telemarketer database, a blacklist database, and a registered sex offender database to include in the message sent to the TV network.

19. The system of claim 18 wherein the message sent to the TV network includes calling party information from a sex offender database, and at least one of the TV server, the CASM, and the CPE device automatically initiates a command to block or reject the call if no instructions are provided to the CPE device in a predetermined time period.

20. The system of claim 1 wherein the query message is sent due to an existing terminating trigger provisioned in a telecommunications node in the telecommunications network.

21. The system of claim 1 wherein the CASM is configured to access at least one of calling party information and called party information by querying at least one external database.

22. The system of claim 2 wherein the call is resumed after a predetermined time period.

23. The system of claim 1 wherein the CASM is further configured to access subscription data associated with the subscriber from at least one of a database stored inside the CASM, an external database, and a received signaling message.

24. A method for providing an enhanced call alert service via an Internet protocol television (IPTV) network, comprising:
receiving, from a telecommunications network, a query message for a suspended call to a called party device associated with a subscriber for requesting instructions for completing or modifying the call; and
in response to the query from the telecommunications network, sending a message to an IPTV network, wherein the message results in notification of the call to the subscriber via an customer premises equipment (CPE) IPTV device and the requesting of instructions from the subscriber via the CPE device for completing or modifying the call.

25. The method of claim 24 comprising:
receiving the message in the IPTV network; and
transmitting a call alert message that contains calling party information, serves as the request for instructions for completing the suspending call, and is displayed to the subscriber via a display interface, wherein the called party device is not associated with the CPE device.

26. The method of claim 24 wherein the called party device is not directly connected to the CPE device.

27. The method of claim 24 wherein the query message includes an IDP message and the message includes a call alert signal.

28. The method of claim 25 comprising:
receiving a user control signal from the subscriber responding to the displayed call alert message, wherein the user control signal provides instructions for completing or modifying the call.

29. The method of claim 25 comprising providing the user control signal to the CPE device via a remote controller.

30. The method of claim 29 wherein the user control signal includes a signal for at least one of: resuming the call, resuming the call after a delay, resuming and redirecting the call a subscriber-specified called device, resuming and redirecting the call to a voice mail server, and rejecting the call.

31. The method of claim 30 comprising:
providing an announcement message to a calling party associated with the call after a delay.

32. The method of claim 28 comprising:
receiving the user control signal from the CPE device; and
forwarding a user response message including instructions provided by the user control signal to a call alert service mediator (CASM).

33. The method of claim 25 wherein the called party device is one of a plurality of called party devices not associated with the CPE device.

34. The method of claim 33 wherein the called party device includes at least one of a mobile phone device and a session initiation protocol (SIP) phone device.

35. The method of claim 32 wherein the CASM is located in the telecommunications network.

36. The method of claim 25 wherein the CPE device is located in a customer premises.

37. The method of claim 25 wherein the display interface includes a television screen.

38. The method of claim 25 comprising:
determining based on called party location information, whether the called party device is proximately located to the CPE device, and, in response to determining that the called party device is not proximately located to the CPE device, refraining from forwarding the message to the CPE device and, in response to determining that the called party device is proximately located to the CPE device, forwarding the message to the CPE device.

39. The method of claim 25 comprising:
determining based on called party presence information and called party location information, whether the called party device is available in a location proximate to the CPE device, and, in response to determining that the called party device is not available in the location proximate to the CPE device, refraining from forwarding the message to the CPE device and, in response to determining that the called party device is available in the location proximate to the CPE device, forwarding the message to the CPE device.

41. A computer readable medium having stored thereon computer executable instructions that when executed by a processor of a computer perform steps comprising:
receiving, from a telecommunications network, a query message for a call to a called party device associated with a subscriber for requesting instructions for completing the call; and
in response to the query from the telecommunications network, sending a message to an IPTV network, wherein the message results in notification of the call to the subscriber via an customer premises equipment (CPE) IPTV device and the requesting of instructions from the subscriber via the CPE device for completing the call.
